(19) United States
(12) Patent Application Publication
(10) Pub. No.: US 2011/0271580 A1
(43) Pub. Date: Nov. 10, 2011

(54) FISHING POLE CONVERTIBLE HIKING ROD

(76) Inventor: Jake Carse, Vancouver, WA (US)

(21) Appl. No.: 13/099,673

(22) Filed: May 3, 2011

Related U.S. Application Data
(60) Provisional application No. 61/332,156, filed on May 6, 2010.

(51) Int. Cl. A01K 87/00; A45B 3/00; A01K 87/06

(52) U.S. Cl. 43/18.1 CT; 43/22; 135/66

(57) ABSTRACT

A hiking and fishing system is described. The hiking and fishing system generally comprises a staff including a staff handle into which at least a portion of a fishing rod may be inserted into a staff cavity. When the fishing rod is inserted into and enclosed by the staff cavity, the hiking and fishing system may function as a hiking staff or stick. Further, the fishing rod is substantially protected by the staff and staff handle. When the fishing rod is removed from the staff cavity and attached to the staff end, and a fishing reel is detachably engaged to the reel mount, the hiking and fishing system may function as a fishing rod.

### CROSS-REFERENCE TO RELATED APPLICATION

The present application claims the benefit of and priority to U.S. Provisional application No. 61/332,156 filed on May 6, 2010, incorporated herein by reference.

### FIELD OF THE INVENTION

The present invention relates to a recreational device. More particularly, the present invention relates to a recreational device simultaneously useful for hiking and fishing.

### BACKGROUND

Recreational and sport fishing is a popular pastime. So too is hiking, backpacking, and camping. Often, hikers and backpackers included fishing along with their hiking and backpacking adventures. Similarly, fisherman may need to hike to their favorite fishing spots. Alternately or additionally, the hikers and fishermen alike may be children or adolescents. For each of the above examples, the fishing equipment (in particular the fishing rod and reel) should be both highly portable and durable. Further, the fisherman, hiker, backpacker, and/or camper may be aided in their adventures by a hiking staff or stick.

A number of devices have provided a combination hiking and fishing device. However, presently known art fail to teach or disclose the features of an embodiment of the present invention either alone or in combination. The following represents a list of known related art:

| | | Date of |
|---|---|---|
| Reference: | Issued to: | Issue/Publication: |
| SU1321392 (A1) | Karbivnichij | Jul. 7, 1987 |
| FR720889 (A) | Francois | Feb. 25, 1932 |
| US 2007/0204895 | Govero | Sep. 6, 2007 |
| US 2002/0104560 | Kelley | Aug. 8, 2002 |
| U.S. Pat. No. 7,210,264 | Demetris | May 1, 2007 |
| U.S. Pat. No. 2,566,647 | Wissman | Sep. 4, 1951 |
| U.S. Pat. No. 1,972,518 | Grandjean | Sep. 4, 1934 |
| U.S. Pat. No. 1,442,813 | Lobit | Jan. 23, 1923 |
| U.S. Pat. No. 1,406,268 | Madej | Feb. 14, 1922 |
| U.S. Pat. No. 1,336,088 | Poremba | Apr. 6, 1920 |
| U.S. Pat. No. 1,324,554 | Kozlowski | Dec. 9, 1919 |
| U.S. Pat. No. 1,310,452 | Sliwinski | Jul. 22, 1919 |
| U.S. Pat. No. 1,283,015 | Yung | Oct. 29, 1918 |
| U.S. Pat. No. 1,020,044 | McGuire | Mar. 12, 1912 |
| U.S. Pat. No. 849,481 | Lobit | Apr. 9, 1907 |
| U.S. Pat. No. 706,225 | Ekelund | Aug. 5, 1902 |
| U.S. Pat. No. 475,852 | Edgerly | May 31, 1892 |
| U.S. Pat. No. 465,254 | Felker | Dec. 15, 1891 |
| D154,065 | Phillips et al. | Jun. 7, 1949 |

The teachings of each of the above-listed citations (which does not itself incorporate essential material by reference) are herein incorporated by reference. None of the above inventions and patents, taken either singularly or in combination, is seen to describe the instant invention as claimed.

### SUMMARY AND ADVANTAGES

An embodiment of a fishing and hiking system comprises a staff; a basket coupled to the staff, the basket including a line guide; a handle coupled to the staff wherein the staff and the handle define a cavity therein; and a fishing rod to removably insert substantially completely into the cavity, the fishing rod to further detachably engage the staff when removed from the cavity. The handle may further comprise a reel mount to detachably engage a fishing reel. The handle may further comprise a finger grip adjacent the reel mount. The hiking and fishing system may further comprise a handle end cap and a staff end cap to couple to the handle and the staff respectively to substantially enclose the cavity with the fishing rod inserted therein. The fishing rod may further comprise at least one line guide coupled to the fishing rod at a fishing rod tip. The fishing rod may further comprise a ferrule to detachably engage the staff.

The hiking and fishing system of the present invention presents numerous advantages, including: (1) is convertible between a hiking stick or staff and a fishing rod; (2) protects the fishing rod when not in use; (3) obviates the need to separately carry a hiking stick or staff and a fishing rod; (4) functions substantially as a regular fishing rod when configured as a fishing rod; (5) makes the fishing rod more interesting to a child or adolescent; (6) provides a fisherman with support while hiking to a fishing spot; and (7) may have an adjustable length to accommodate hikers of varying heights and/or to adjust its fishing characteristics.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an embodiment of hiking and fishing system.

FIG. 2 shows a different view of the hiking and fishing system.

FIG. 3 shows the staff and basket of the hiking and fishing system.

FIG. 4 shows the staff handle and fishing reel of the hiking and fishing system.

FIG. 5 shows the basket line guide of the hiking and fishing system.

FIG. 6 shows the fishing rod coupled to the staff end of the hiking and fishing system.

FIG. 7 shows the staff handle and staff handle end of the hiking and fishing system.

FIG. 8 shows the fishing rod inserted into the staff cavity of the hiking and fishing system.

FIG. 9 shows the staff handle and staff handle cap of the hiking and fishing system.

FIG. 10 shows the staff including a staff coupling member to alter the length of the staff.

FIG. 11 shows the staff including the staff coupling member of FIG. 10 with the shaft length extended.

FIG. 12 shows the hiking and fishing system 110 in a hiking configuration.

FIG. 13 shows the hiking and fishing system 110 in a fishing configuration.

### REFERENCE NUMBERS USED IN DRAWINGS

Turning now descriptively to the drawings, in which similar reference characters denote similar elements throughout the several views, the figures illustrate the hiking and fishing system of the present invention. With regard to the reference numerals used, the following numbering is used throughout the various drawing figures:
10 hiking and fishing system
20 staff
22 staff base
24 staff extension
26 staff coupling member
30 staff handle
32 staff finger grip
34 reel mount
35 staff handle cap
36 staff handle end
38 staff cavity
40 basket
42 basket line guide
44 basket teeth
45 staff end cap
46 staff end
50 fishing rod
52 fishing rod ferrule
60 fishing rod line guide
70 fishing reel
110 hiking and fishing system
120 staff
122 staff base
124 staff extension
126 staff coupling member
130 staff handle
131 handle coupling member
133 hand grip
134 reel mount
138 staff cavity
140 basket
142 basket line guide
145 staff end cap
146 staff end
148 fishing rod upper section
150 fishing rod lower section
160 fishing rod line guide

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

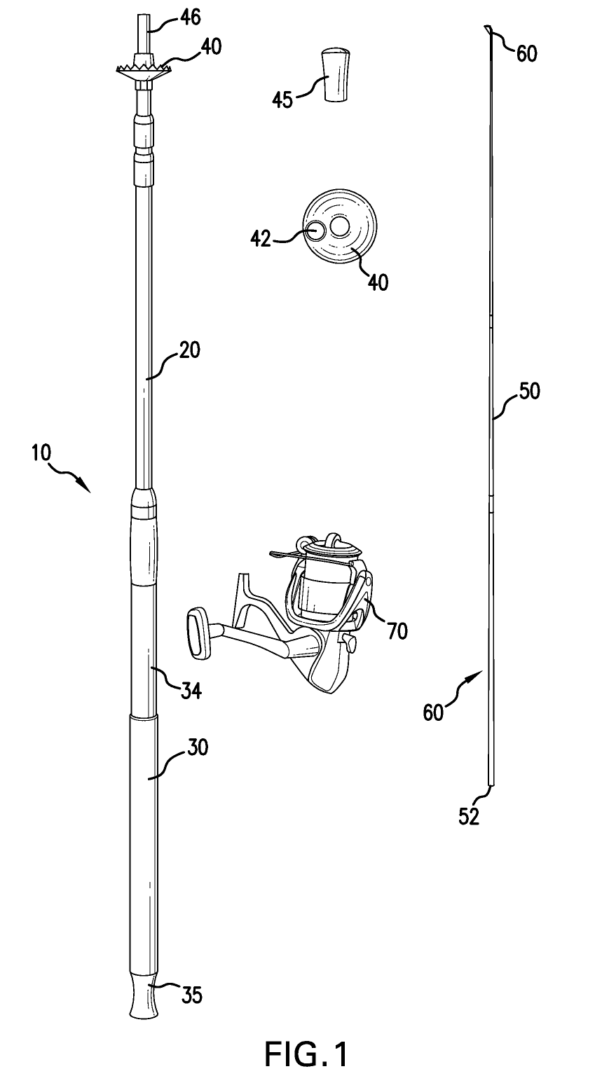

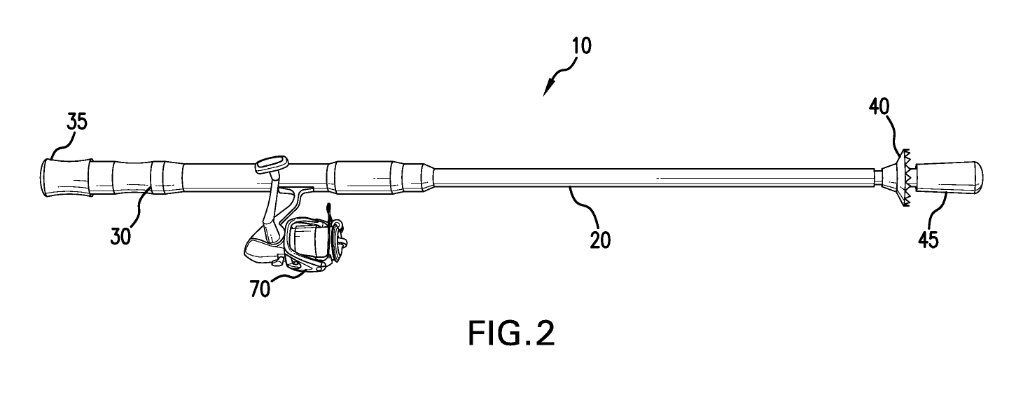

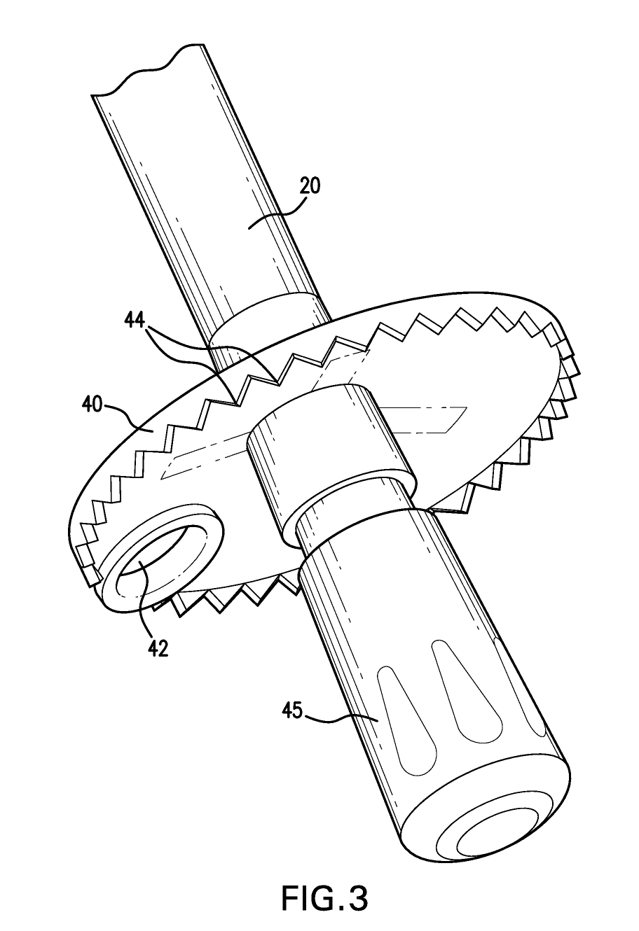

As shown in FIGS. 1-11, a hiking and fishing system 10 is provided. As generally shown in FIGS. 1 and 2, hiking and fishing system 10 generally comprises a staff 20 including a staff handle 30 into which at least a portion of a fishing rod 50 may be inserted into a staff cavity 38. In one embodiment, the staff cavity 38 extends through the staff handle 30 into non-handle portions of the staff 20. When the fishing rod 50 is inserted into and enclosed by the staff cavity 38, the hiking and fishing system 10 may function substantially as a hiking staff or stick. Further, the fishing rod 50 may be substantially protected by the staff 20 and staff handle 30. When the fishing rod 50 is removed from the staff cavity 38 and attached to the staff end 46, and a fishing reel 70 is detachably engaged to a reel mount 34 on the staff 20, the hiking and fishing system 10 may function substantially as a fishing rod. When the fishing is complete, the fishing rod 50 may be inserted back into the staff cavity 38 for both portability and protection. The details of the hiking and fishing system 10 may be described in detail with reference to FIGS. 3-11.

FIG. 3 shows the staff 20 and basket 40 of the hiking and fishing system. More specifically, the staff 20 may terminate at staff end 46. The staff end 46 may be covered and protected by staff end cap 45. In one embodiment, the staff end cap 45 may be plastic, rubber, or any other durable material that may aid the friction and/or traction of the hiking and fishing system 10 when used as a hiking staff or stick. The staff end cap 45 may couple to the staff end 46 with a friction coupling, a threaded coupling, or a combination thereof. A basket 40 may couple to the staff 20 adjacent the staff end 46. In one embodiment, the basket 40 may be configured to substantially prevent over penetration of the staff 20 into soft ground, for example mud and snow. For example, depending on the soft ground, the basket 40 size may be larger or smaller. For significantly soft ground, the basket 40 size may be increased compared to the basket 40 size for harder or firmer ground. The basket 40 may further include features such as a plurality of basket teeth 44 to increase the traction the basket 40 with the ground. The basket 40 may also include a basket line guide 42 formed therein. More specifically, the basket line guide 42 may be a ceramic and/or other substantially low friction line guide through which fishing line (not illustrated) may extend when the hiking and fishing system 10 is configured for fishing.

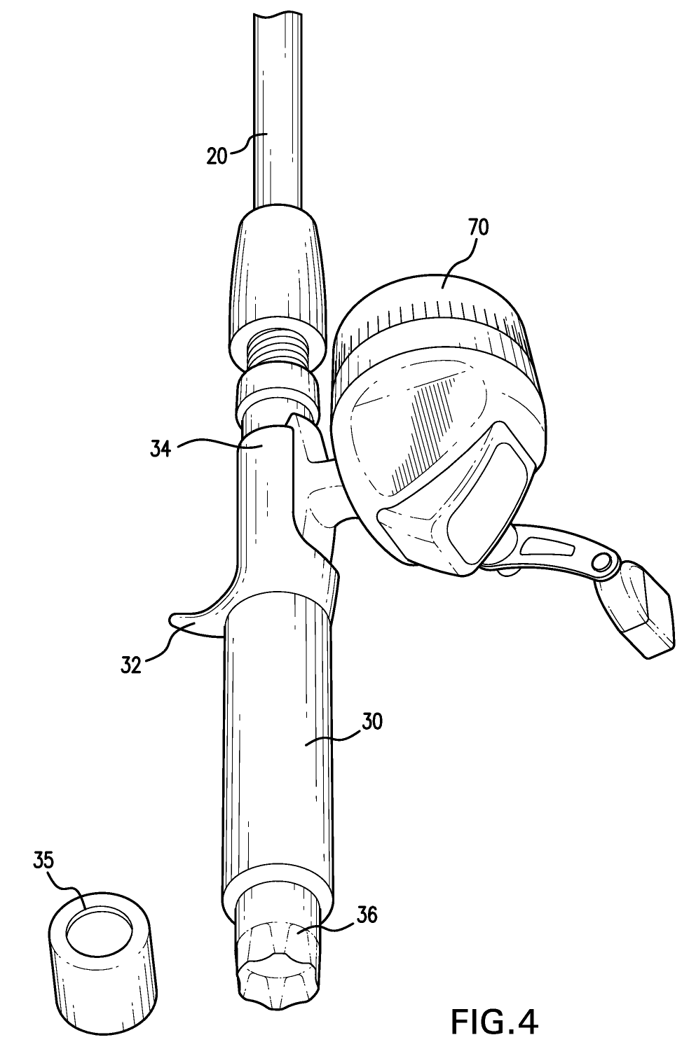

FIG. 4 shows the staff handle 30 and fishing reel 70 of the hiking and fishing system. More specifically, the staff handle 30 may include a staff finger grip 32, a reel mount 34 with a fishing reel 70 detachably engaged thereto, and a staff handle end 36 onto which a staff handle cap 35 may detachably engage to substantially protect the staff handle end 36 and the staff cavity 38 formed therein. Further, the staff handle cap 35 may substantially protect the fishing rod 50 and prevent the extrusion of the fishing rod 50 from the staff cavity 38 when included therein as the hiking and fishing system 10 is configured for hiking. The staff handle cap 35 may couple to the staff handle end 36 with a friction coupling, a threaded coupling, or a combination thereof.

The fishing reel 70 removably couples to the staff handle 30 with the reel mount 34. In one embodiment, the reel mount 34 may be a threaded coupling as well known in the fishing rod arts. Other detachable couplings, for example a frictional detachable couplings may be used. The fishing reel 70 may be any type of fishing reel, for example, a spin cast reel (as illustrated), a bait casting reel, a spinning real, or any other type of fishing reel. The illustrated spin cast fishing reel 70 may be simpler to operate than other types of fishing reels, and may allow the hiking and fishing system 10 to be successfully deployed by an adolescent, child, or any other fisherperson that may have limited manual dexterity and/or fishing experience. Though not illustrated, the fishing reel 70 may be filled with fishing line suitable for the type of fishing reel 70, the style and/or size of the fishing bait (also not illustrated) to be used, and/or the species of fish for which the hiking and fishing system 10 may be deployed.

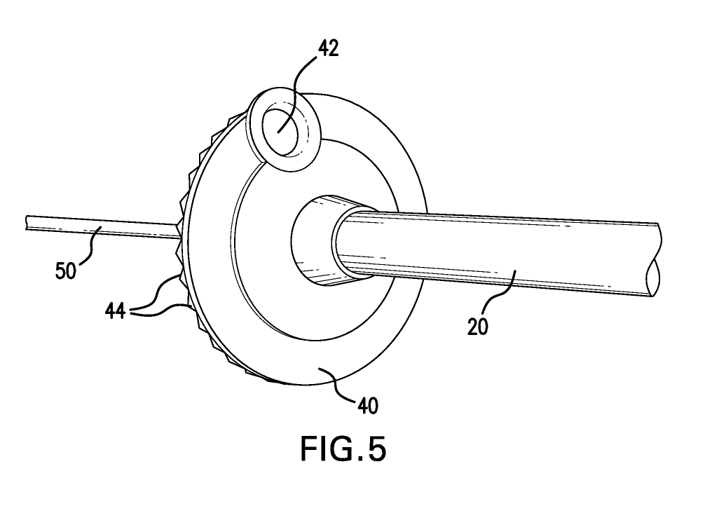

FIG. 5 shows the basket line guide 42 of the hiking and fishing system 10. As introduced above, the staff 20 may terminate with a basket 40 adjacent the staff end 46. With the staff end cap 45 removed, and the fishing rod 50 detachably engaged to the staff end 46, the basket line guide 42 may be the first line guide to guide and/or control the fishing line as it spools from (e.g., during a cast) and/or is reeled in with fishing reel 70. Further, the basket line guide 42 may substantially or completely prevent the fishing line from otherwise contacting the basket 40 that would likely damage the fishing line to the point of failure. In one embodiment, the basket line guide 42 may be a ceramic and/or other substantially low friction line guide. More specifically, the basket line guide 42 may be a circular basket line guide 42 formed from polished metal (e.g., steel or titanium), a polished ceramic (e.g., aluminum oxide), or a combination thereof. Further, the basket line guide 42 may be treated with and/or coated by a low friction material such as titanium nitride. The low friction surface and substantially circular shape of the basket line guide 42 may substantially mitigate frictional damage caused to the fishing line as it is cast and retrieved through the basket line guide 42, in particular when the fishing line is under tension for example when retrieving a fishing bait and/or fighting a fish that has been hooked by the fishing bait. The low friction surface and substantially circular shape of the basket line guide 42 may further aid the distance a fishing bait may be cast.

In one embodiment, the basket line guide 42 may be integrally formed in or inserted into the basket 40. For example, the basket 40 material (in one embodiment, a thermoplastic or a thermosetting polymer with or without fiber reinforcement) may be molded or otherwise formed around the basket line guide 42. The basket line guide 42 may be alternately or additionally bonded and/or adhered to the basket 40 with any substantially water-resistant or waterproof adhesive or bonding material. The basket line guide 42 may be formed and/or attached substantially completely within the basket 40 so that it may not protrude from the edge of the basket 40. For the substantially circular basket 40 illustrated, the basket line guide 42 may not extend past the radius of the basket 40 so that the basket 40 may substantially function as it would in the absence of the basket line guide 42. Further, the integral formation and/or inclusion of the basket line guide 42 in the basket 40 may substantially protect the basket line guide 42 from damage as would be more likely if the basket line guide 42 protruded from the basket 40.

Further, the size of the basket line guide 42 (e.g., diameter of the circular basket line guide 42) as well as the offset from the staff 20/fishing rod 50 longitudinal axis may be configured differently depending on the type of fishing reel 70 to be deployed with the hiking and fishing system 10. For example, for a bait casting reel (not illustrated), both the size and offset of the basket line guide 42 may be smaller than the size and offset of the basket line guide 42 configured for a spinning reel (also not illustrated).

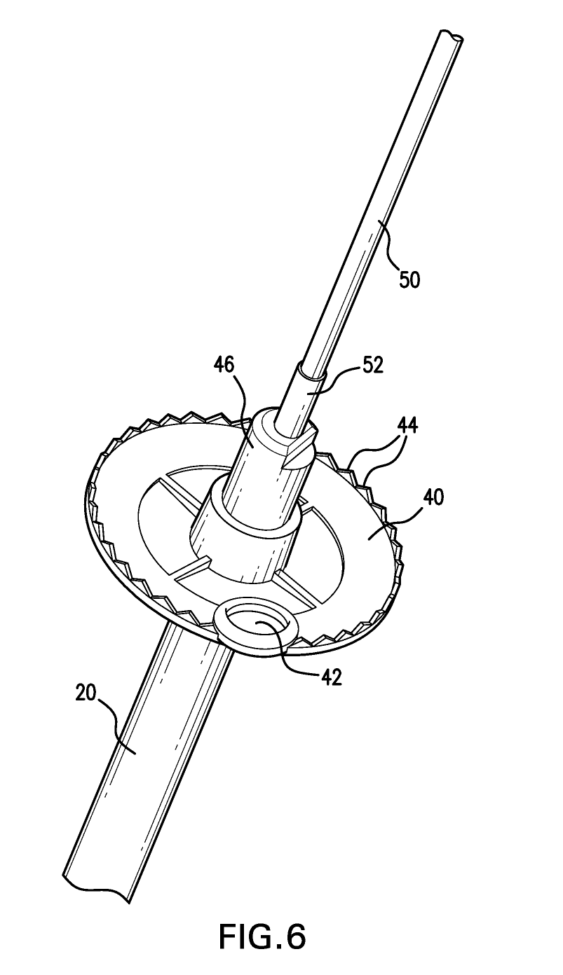

FIG. 6 shows the fishing rod 50 coupled to the staff end of the hiking and fishing system 10. In one embodiment, the fishing rod 50 may be formed from bamboo, fiberglass, carbon fiber, graphite, boron, and/or composites or combinations thereof. Depending on its length (e.g., as limited by the maximum length that may be substantially completely and stowed in the staff cavity 38 that extends into the staff 20), the fishing rod 50 may have a stiffness, modulus, or “IM” configured for the type of fishing for which the hiking and fishing system 10 will be deployed.

Unlike standard fishing rods for which the entire length of the fishing rod is a single continuous shaft of bamboo, fiberglass, carbon fiber, graphite, boron, and/or composites or combinations thereof (or multiple pieces that may be coupled together to effectively form the same), the fishing rod 50 may form only approximately half of the overall length of the hiking and fishing system 10. Further, the remaining half (e.g., as formed by the staff 20 and the staff handle 30) may be substantially inflexible. Accordingly, to function approximately as would a standard fishing rod, the fishing rod 50 may include a stiffer portion adjacent the staff end 46 to aid the detachable coupling strength of the fishing rod 50 to the staff end 46 and a substantially flexible tip end distal from the staff end 46 to improve the ability of the hiking and fishing system 10 to cast fishing baits or lures and to properly fight a fish hooked thereto.

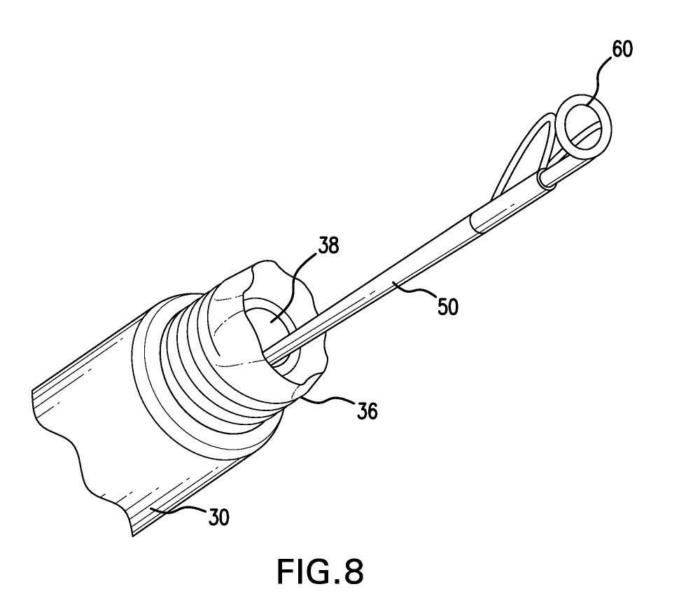

Further, and as illustrated by FIG. 8, the fishing rod 50 may include at least one fishing rod line guide 60 at the distal tip of the fishing rod 50. In an alternate embodiment, the fishing rod 50 may include one fishing rod line guide 60 at the distal tip of the fishing rod 50 and at least one more fishing rod line guide 60 spaced along the fishing rod 50. For example, with one additional fishing rod line guide 60, the fishing rod line guide 60 may be positioned at approximately the midpoint of the fishing rod 50. Numerous fishing rod line guides 60, in combination with the basket line guide 42, may increase the control with which the hiking and fishing system 10 may cast and retrieve the fishing line. Too many fishing rod line guides 60, however, may generate additional friction with the fishing line and reduce the casting distance of which the hiking and fishing system 10 is capable and increase the staff cavity 38 volume necessary to receive and stow the fishing rod 50. Accordingly, the fishing rod 50 may be configured with a number of fishing rod line guides 60 to balance the fishing line control with the casting friction depending on the length and action of the fishing rod 50.

FIG. 6 further illustrates that the proximal end of the fishing rod 50 may include a fishing rod ferrule 52 to insert into the staff end 46 to detachably couple the fishing rod 50 to the staff 20. In one embodiment, the fishing rod ferrule 52 may be a metal sheath substantially enclosing the proximal end of the fishing rod 50 to protect the end of the fishing rod 50 from wear, de-lamination, and/or fiber separation as the fishing rod 50 is inserted into and removed from the staff end 46. Further, the fishing rod ferrule 52 may provide a more consistent and durable frictional coupling with the staff end 46 to substantially secure the fishing rod 50 in the end of the staff end 46 while nevertheless providing a frictional coupling that may be decoupled without substantial stress and/or strain on the staff end 46 and/or the fishing rod 50 to substantially avoid damage to either as they are repeatedly coupled and decoupled during the lifespan of the hiking and fishing system 10.

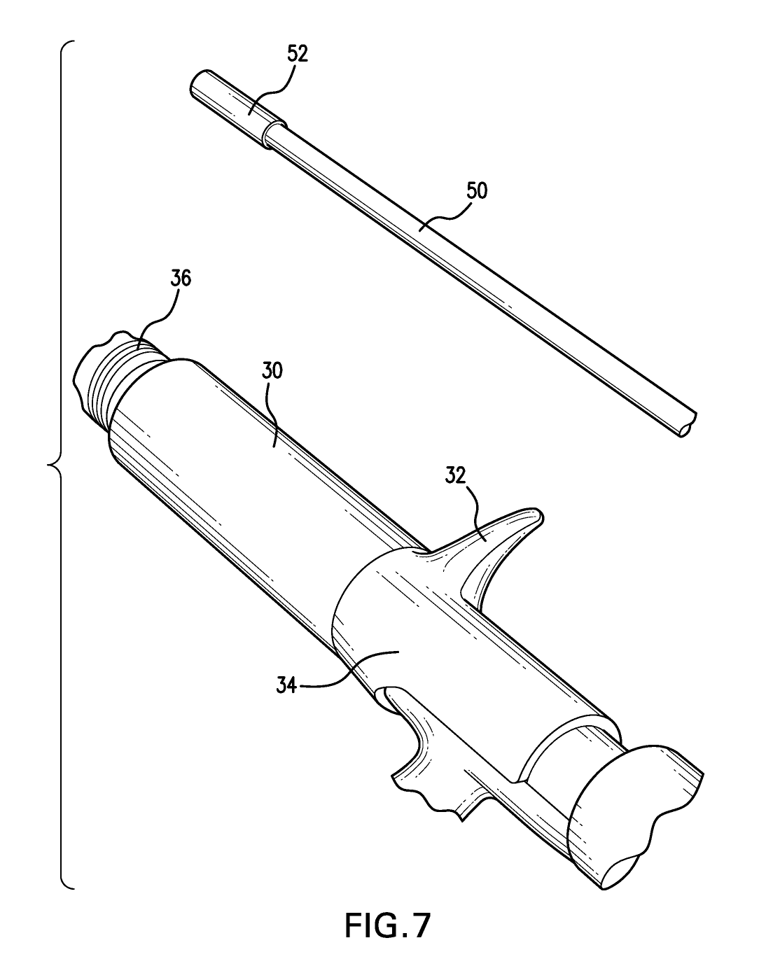

FIG. 7 shows the staff handle 30 and staff handle end 36 of the hiking and fishing system 10 and the proximal end of the fishing rod 50 including the fishing rod ferrule 52 detached from the staff end 46. In one embodiment, the staff 20 may be formed from a metal (e.g., aluminum, stainless steel, titanium, or other metal alloy that may be exposed to fresh and salt water substantially without rusting and/or otherwise corroding), a composite material (e.g., fiberglass, carbon fiber, graphite, boron, and/or combinations thereof), and/or a combination thereof. Further, at least the staff 20 may include a decorative color, design, or the like (e.g., in the form of paint, adhered designs, and the like). For example, in particular for adolescent or child hikers and fishermen, at least the staff 20 may include age-appropriate and/or gender specific decoration. In one embodiment, substantially the entire length of the staff 20 and staff handle 30 may define a staff cavity 38 having a diameter sufficient to receive and stow the fishing rod 50 including any fishing rod line guides 60 attached thereto. In one embodiment, the staff handle 30 may be formed from substantially the same material as the staff 20 (e.g., the staff handle 30 may be an extension of the staff 20). For such an embodiment, the staff handle 30 may include additional grip features and or materials such as cork, rubber, a foam rubber, an elastomer, and/or a combination thereof. Further, the staff handle may include one or more protrusions, for example, the staff finger grip 32, to aid the manipulation of the staff handle when the hiking and fishing system 10 is configured for hiking, fishing, or both. The reel mount 34 may be at least partially integrally formed in the staff handle 30 or it may be a separate component attached to the staff handle 30. Though not illustrated, the staff handle 30 may further include a lanyard, strap, or other retention device that may couple to the arm, wrist, hand, or the like of a user deploying the hiking and fishing system 10.

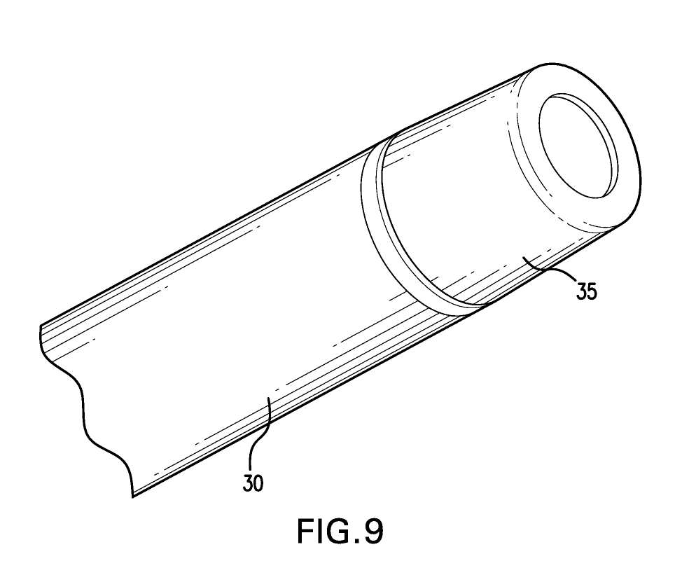

FIG. 8 shows the fishing rod 50 inserted into the staff cavity 38 of the hiking and fishing system 10. As noted, the staff cavity 38 extends through the staff handle 30 at least partially into (and in one embodiment, substantially completely through) the staff 20. The staff cavity 38 is accordingly long enough and wide enough (e.g., has sufficient diameter) to accommodate the fishing rod 50 including the one or more fishing rod line guides 60. FIG. 9 shows the staff handle 30 and staff handle cap 35 of the hiking and fishing system 10 once the staff handle cap 35 has been detachably engaged to the staff handle end 36 to substantially removably secure the fishing rod 50 in the staff cavity 38. The staff handle cap 35 may couple to the staff handle end 36 with a friction coupling, a threaded coupling, or a combination thereof.

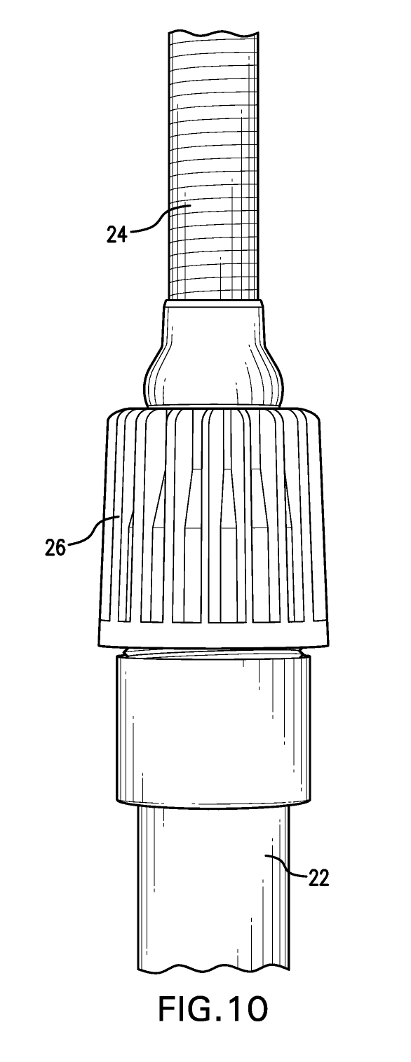

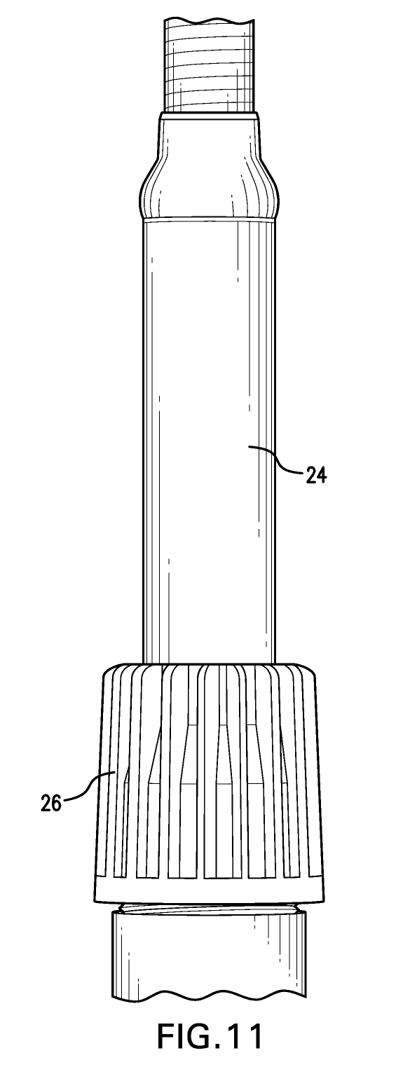

Though described with reference to the staff 20 having a fixed or predetermined length, in an alternate embodiment the staff 20 has an adjustable length. For example, FIGS. 10 and 11 illustrate that the staff 20 may telescope or otherwise change in length so that it may be used, for example, by hikers of varying height. More specifically, the staff 20 may comprise a staff base 22 that couples to the staff handle 30 and a staff extension 24. The staff extension 24 may couple to the staff base 22 with a staff coupling member 26.

For example, in one embodiment, the staff extension 24 and the staff base 22 may both be substantially tubular and/or have a substantially circular cross section. In one embodiment for which the staff extension 24 and staff base 22 are tubular, the outside diameter of the staff extension 24 may be smaller than the inside diameter of the staff base 22 so that the staff extension 24 may retract into and/or extend from the staff base 22. The staff coupling member 26 may be a tubular twist locking collar. For example, by twisting the staff coupling member 26, the staff extension 24 may be substantially locked and unlocked within the staff base 22. Accordingly, the staff coupling member 26 may loosen so that the overall length of the hiking and fishing system 10 may be adjusted to the height of the hiker and/or fisher and then tighten to substantially lock the length of the hiking and fishing system.

In addition to configuring the overall length of the hiking and fishing system 10 to correspond to hikers of various heights, altering the length of, for example, the staff extension 24 that protrudes and/or extends from the staff base 22 may further adjust and/or tune the hiking and fishing system 10 when configured to fish. For example, the overall length of the hiking and fishing system 10 configured for a particular hiker may not be the same overall length that would be best suited for fishing based on, for example, the length and configuration of the fishing rod 50, the location of the basket 40 including basket line guide 42, and the location of the fishing reel 70.

In one embodiment, the staff coupling member 26 may form a substantially water resistant and/or waterproof seal between the staff base 22 and the staff extension 24 so that water does not intrude into the interior of either the staff 20, the staff handle 30, etc., when the staff extension 24 and at least a portion of the staff base 22 are submerged. Substantially preventing water and/or other dirt or grit from intruding into the interior of at least the staff 20 (including the staff base 22, staff extension 24, and the staff coupling member 26) and the staff handle 30 may, for example, protect the fishing rod 50 and any interior components of the hiking and fishing system 10 against corrosion and/or degradation caused by intruding water, dirt, and grit.

Further, though not illustrated, the basket 40 may be interchangeable so that basket 40 size may be changed to accommodate various hiking surfaces and/or size, location, and configuration of the basket line guide 42 (e.g., to correspond to a particular type of fishing reel 70, fishing rod 50 configuration, or a combination thereof). Further still, the hiking and fishing system 10 may be provided with various fishing rod 50 types and/or configurations to correspond to various fishing applications. For example, a hiking and fishing system 10 configured for a child may include a shorter staff 20, and a fishing rod 50, basket line guide 42, staff handle 30, reel mount 34, or a combination thereof configured for a spin cast fishing reel 70 common to adolescent or child fishing rods. The hiking and fishing system 10 configured for an adult may include a relatively longer staff 20, and a fishing rod 50, basket line guide 42, staff handle 30, reel mount 34, or a combination thereof configured for a bait casting and/or spinning fishing reel 70 common to adult fishing rods. The embodiments are not limited in this context.

In one embodiment, the hiking and fishing system 10 may have two configurations, namely a hiking configuration and a fishing configuration. For the hiking configuration, the fishing rod 50 may be inserted into and stowed in the staff cavity 38, the staff handle cap 35 coupled to the staff handle end 36, and the staff end cap 45 coupled to the staff end 46. As configured, the hiking and fishing system 10 may function substantially as a hiking stick or hiking staff. To convert the hiking and fishing system 10 to the fishing configuration, staff handle cap 35 and the staff end cap 45 may be removed, the fishing rod 50 withdrawn and then coupled to the staff end 46, and then the staff handle cap 35 may be returned to the staff handle end 36. To convert the hiking and fishing system 10 back to the hiking configuration, the staff handle cap 35 may be removed, the fishing rod 50 may be detached from the staff end 46 and inserted into the staff cavity 38, and the staff handle cap 35 and staff end cap 45 may be returned to the staff handle end 36 and staff end 46 respectively. During the conversion between hiking configuration and fishing configuration, the fishing reel 70 may or may not be detached from the reel mount 34.

Further, whether configured to hike or to fish, the length of the hiking and fishing system 10 may be adjusted (e.g., lengthened and/or shortened), for example, by actuating the staff coupling member 26. In one embodiment, actuating the staff coupling member 26 may include twisting the staff coupling member 26 to substantially lock and unlock the staff extension 24 within the staff base 22 to adjust the portion of the staff extension 24 that protrudes and/or extends from the staff base 22.

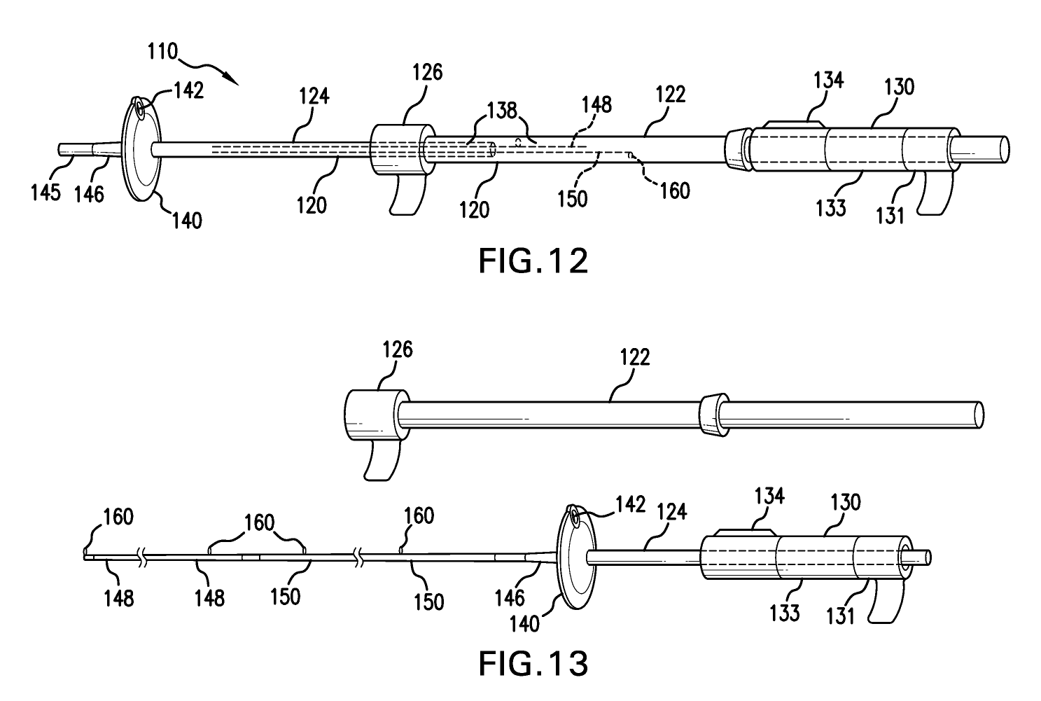

FIGS. 12 and 13 show another embodiment of a hiking and fishing system 110. The hiking and fishing system 110 can be configured in a hiking configuration (FIG. 12) and in a fishing configuration (FIG. 13). This embodiment of the hiking and fishing system 110 includes a staff 120 comprising a staff base 122, a staff extension 124, and a staff handle 130.

The staff base 122 and staff extension 124 are tubular and rigid in the context of forces that a typical person would apply while using a hiking staff. The staff extension 124 is configured to be partially inserted into the staff base 122 when in the hiking configuration. The staff extension 124 staff and base 122 have cross-sections that are circular, but in other embodiments they may be oval or some other suitable shape. The staff extension 124 has an outside cross-section smaller than an inside cross-section of the staff base 122. Typically, the fit between them is tight enough to produce some friction, but not enough to prevent a user from inserting or removing the staff extension 124 by hand. In some embodiments, the staff base 122 is configured to be partially inserted into the staff extension 124 with the staff base 122 having an outside cross-section smaller than an inside cross-section of the staff extension 124.

The user is able to select a distance to insert the staff extension 124 into the staff base 122. Changing the selected distance will change the overall length of the staff 120, adapting it for different statured hikers and for different conditions. A staff coupling member 126 is configured to couple the staff base 122 to the staff extension 124 in a fixed position relative to each other. In the embodiment shown in FIGS. 12-13, the staff coupling member 126 is a locking clamp, which is attached to the staff base 122 and holds the staff extension 124 with friction. The locking clamp may be similar to the one described in U.S. Pat. No. 5,441,307, incorporated herein by reference. In other embodiments, the staff coupling member 126 is a locking collar or some other similar device.

The staff handle 130 is rigid and tubular, having an inside cross-section larger than an outside cross-section of the staff base 122. The staff handle 130 is configured to be slid concentrically over the staff base 122 and detachably coupled thereto when in the hiking configuration. The staff handle 130 has a handle coupling member 131 configured to couple the staff handle 130 to the staff base 122 in a fixed position relative to each other. The handle coupling member 131 is similar to the staff coupling member 126. In the embodiment shown in FIGS. 12-13, the handle coupling member 131 is a locking clamp, but in other embodiments can be a locking collar or similar device.

The staff handle 130 has a hand grip 133 and a reel mount 134. The hand grip 133 is positioned in the staff handle 130 above the reel mount 134 so that in the hiking configuration, the user can comfortably grasp the hand grip 133 while not contacting the reel mount 134. The hand grip 133 is constructed of foam rubber or some other suitable material, several of which are discussed above regarding the embodiment of FIGS. 1-11.

The staff 120 has a staff cavity 138, defined by the interior spaces of the staff base 122 and the staff extension 124. A fishing rod upper section 148 and a fishing rod lower section 150 are stored in the staff cavity 138. In some embodiments, additional fishing rod section may be stored in the staff cavity 138 (to make a longer fishing rod) and in other embodiments, only a single fish rod section may be stored. The fishing rod upper section 148 and fishing rod lower section 150 are flexible enough to be bent by hand and are constructed of typical fishing rod material such as carbon fiber or other materials noted in discussion of the embodiment of FIGS. 1-11. The fishing rod upper section 148 and fishing rod lower section 150 have multiple fishing rod line guides 160.

The staff extension 124 terminates at a staff end 146 and is protected by a staff end cap 145. The staff extension 124 has a basket 140 and basket line guide 142. The staff end 146, staff end cap 145, basket 140 and basket line guide 142 are similar in construction and function as the corresponding components discussed above regarding the embodiments shown in FIGS. 1-11.

FIG. 13 shows the hiking and fishing system 110 in the fishing configuration. The staff coupling device 126 has been released; the staff base 122 and the staff extension 124 have been decoupled and separated. The staff end cap 145 has been removed from the staff end 146. The fishing rod upper section 148 and the fishing rod lower section 150 have been removed from the staff cavity 138, and assembled. The staff rod lower section 150 has been coupled to the staff end 146 in a manner similar to the ones discussed above regarding the similar components in the embodiments shown in FIGS. 1-11. The staff handle 130 has been decoupled and removed from the staff base 122, then slid concentrically over the staff extension 124 and detachably coupled thereto. The staff handle 130 can be slid a selectable distance along the staff extension 124, allowing the user to adjust the balance of the hiking and fishing system 110 in the fishing configuration. A fishing reel (not shown) may be attached to the reel mount 134. The resulting hiking and fishing system 110 in the fishing configuration has a short rigid handle section and long flexible pole section, which is ideal for most types of fishing. If a longer pole is desired, the user has an option, after the fishing rod upper section 148 and fishing rod lower section 150 have been removed from the staff cavity and coupled the staff extension 124, of re-coupling the staff extension 124 to the staff base 122, leaving the staff handle 130 coupled to the staff base 122. In some embodiments, the basket 140 is removed in the fishing configuration and replaced with a fishing line guide that couples to the staff extension 124 or staff end 146.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A hiking and fishing system, comprising:
a staff with a staff end, wherein the staff has a staff cavity therein;
a staff handle coupled to the staff;
a basket coupled to the staff, the basket including a basket line guide; and
a fishing rod configured to removably insert substantially inside the staff cavity, the fishing rod further configured to detachably engage the staff end when removed from the staff cavity.

2. The hiking and fishing system of claim 1, the staff handle further comprising a reel mount configured to detachably engage a fishing reel.

3. The hiking and fishing system of claim 2, the staff handle further comprising a staff finger grip adjacent the reel mount.

4. The hiking and fishing system of claim 1 further comprising:
a staff handle cap configured to detachably engage with the staff handle, thereby substantially enclosing the staff cavity; and
a staff end cap configured to detachably couple to the staff end.

5. The hiking and fishing system of claim 1, the fishing rod further comprising at least one fishing rod line guide positioned on the fishing rod at a fishing rod tip.

6. The hiking and fishing system of claim 1, the fishing rod further comprising a fishing rod ferrule configured to detachably engage the staff.

7. The hiking and fishing system of claim 1, wherein the staff is configured to change in length.

8. The hiking and fishing system of claim 1, the staff further comprising:
a staff base; and
a staff extension configured to detachably engage with the staff base to adjust length of the staff.

9. The hiking and fishing system of claim 8, the staff further comprising a staff coupling member configured to detachably engage to the staff extension with the staff base.

10. The hiking and fishing system of claim 9, wherein the staff coupling member is a twist locking collar.

11. A staff that can be configured in a hiking configuration and in a fishing configuration, comprising:
a staff base, rigid and tubular;
a staff extension, rigid and tubular, having an outside cross-section smaller than an inside cross-section of the staff base, configured to be partially inserted a first selectable distance into the staff base and detachably coupled thereto in a fixed position relative to each other when in the hiking configuration and configured to be detached and separated from the staff base when in a fishing configuration;
a staff handle, rigid and tubular, having an inside cross-section larger than an outside cross-section of the staff base, configured to be slid concentrically over the staff base and detachably coupled thereto when in the hiking configuration and configured to be slid concentrically over the staff extension and detachably coupled thereto when in the fishing configuration;
a staff cavity inside the staff extension and staff base;
a fishing rod configured to be stored within the staff cavity when in the hiking configuration; and
a staff end, part of the staff extension, configured to be detachably coupled with the fishing rod when in the fishing configuration.

12. The staff of claim 11, further comprising a staff coupling member configured to detachably couple the staff base to the staff extension when in the hiking configuration.

13. The staff of claim 12, wherein the staff coupling member is a locking clamp.

14. The staff of claim 11, wherein the staff handle configured to be slid concentrically over the staff extension is further configured to be slid a second selectable distance over the staff extension.

15. The staff of claim 11 further comprising a reel mount coupled to the staff handle.

16. A hiking and fishing system that can be configured in a hiking configuration and in a fishing configuration, comprising:
a staff comprising a staff base, a staff extension with a staff end, a staff end cap, a staff coupling member, and a staff handle;
a fishing rod;
wherein the staff base and the staff extension are tubular, configured for one to be concentrically slid onto the other a first selectable distance and coupled thereto in a fixed relative position when in the hiking configuration and configured to be detached from each other for the fishing configuration;
wherein the staff has a staff cavity inside the staff extension and staff base;
wherein the staff end cap is configured to couple to the staff extension when in the hiking configuration and to decouple in the fishing configuration;
wherein the staff handle is tubular and configured to be concentrically slid onto the staff base and coupled thereto when in the hiking configuration and is configured to be concentrically slid onto the staff extension and coupled thereto when in the fishing configuration; and
wherein the fishing rod is configured to be placed inside the staff cavity when in the hiking configuration, the fishing rod further configured to be detachably coupled to the staff end when in the fishing configuration.

17. The staff of claim 16, wherein the staff handle configured to be concentrically slid over the staff extension is further configured to be slid a second selectable distance over the staff extension.

18. The staff of claim 16 further comprising a reel mount coupled to the staff handle.

19. The staff of claim 16 further comprising a basket coupled to the staff, the basket including a basket line guide.

20. The staff of claim 16, further comprising a staff coupling member configured to detachably couple the staff base to the staff extension when in the hiking configuration.
